(19) United States
(12) Patent Application Publication
(10) Pub. No.: US 2026/0065086 A1
(43) Pub. Date: Mar. 5, 2026

(54) Process Optimization System with Machine Learning Model to Optimize Process Execution

(71) Applicant: ORACLE INTERNATIONAL CORPORATION, Redwood Shores, CA (US)

(72) Inventors: John D. CLARK, JR., Pepperell, MA (US); Thomas V. LeFEBVRE, Ridgefield, CT (US)

(21) Appl. No.: 19/187,452

(22) Filed: Apr. 23, 2025

Related U.S. Application Data
(60) Provisional application No. 63/690,956, filed on Sep. 5, 2024.

(51) Int. Cl. G06N 5/022

(52) U.S. Cl. CPC G06N 5/022

(57) ABSTRACT

Systems, methods, and other embodiments associated with a process optimizer are described. In one embodiment, a method includes executing an optimization by inputting, into a trained machine learning model, a candidate process template includes a candidate sequence of tasks to be executed for completing a process type. The machine learning model may evaluate the candidate sequence of tasks including assigned task parameters for executing the process type based on at least learned internalized patterns. The machine learning model may predict one or more delays associated with the candidate sequence of tasks based on similar properties as in the internalized patterns. An optimized sequence of tasks for the candidate process template may be generated by changing an order of the candidate sequence of tasks and changing one or more of the assigned task parameters to reduce the one or more predicted delays.

### CROSS REFERENCE TO RELATED APPLICATIONS

This disclosure claims the benefit of U.S. Provisional Patent Application Ser. No. 63/690,956 filed Sep. 5, 2024, titled “Machine Learning Model to Optimize Process Execution”, inventors: Clark, Jr., et al., and assigned to the present assignee, which is incorporated by reference herein in its entirety

### BACKGROUND

In many computer-implemented systems, task sequencing is a technique for optimizing technical workflows or improving efficiency in an executable process. One common approach to optimizing a sequence of tasks involves using software algorithms that analyze predefined task parameters, such as execution time, resource allocation, dependencies, and priority levels, to determine an optimal order in which the tasks should be performed. These algorithms may also consider historical performance data or user-defined rules to guide the sequencing logic.

Some prior techniques have used heuristics or rule-based logic to reorder tasks so that high-priority or resource-intensive operations are executed first, or tasks that are dependent on the completion of others are properly sequenced. These prior systems relied on a combination of human experience and a set of hardcoded programmed rules. Such programmed rules are based on numerous groups of customized Boolean filter clauses programmed as IF-THEN statements that define specified conditions and criteria. These filter clauses are specific and require experienced programmers who understand all the programming statements and their associated programmed conditions.

However, existing approaches often suffer from several problems and limitations. First, static rule-based systems do not adapt well to changes in process conditions or task variability. As a result, one optimized sequence generated under one set of circumstances may not remain optimal as system inputs or constraints evolve. Any change to a rule would require re-programming the software, recompiling, retesting the code (which is repeated until accurate), and re-deploying the modified program. An optimization system that can dynamically adapt to different conditions would improve upon these prior techniques.

### SUMMARY

In one embodiment, a computing system is configured with a process optimization system that is implemented with machine learning to analyze prior process executions to identify bottlenecks and delays for an organization. Bottlenecks may include, but are not limited to, poor sequencing of tasks, redundancies, system failures, etc. This information may be used to suggest optimizations to a process template for future execution of the process.

In one embodiment, the process optimization system may be configured to: train a machine learning model based on a plurality of historical logs that comprises execution data from multiple execution cycles of a process type; wherein each historical log representing a distinct execution cycle performed at a different time, and containing data showing the process type executed with varying sequences of tasks associated with different performance metrics, and the multiple execution cycles of the process type were initiated based on a standardized process template that is assigned to the process type. The machine learning model may be trained to learn and create internalized patterns that identify delays associated with particular tasks and assigned task parameters, and patterns that identify delays associated with particular sequences of tasks based on at least the different performance metrics. The machine learning model may evaluate and generate an optimized sequence of tasks for a candidate process template by changing an order of the candidate sequence of tasks and changing one or more of the assigned task parameters to reduce one or more predicted delays.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments one element may be implemented as multiple elements or that multiple elements may be implemented as one element. In some embodiments, an element shown as an internal component of another element may be implemented as an external component and vice versa. Furthermore, elements may not be drawn to scale.

FIG. 1 illustrates one embodiment of a process optimization system associated with training a machine learning model to predict and optimize a sequence of tasks for a process type.

FIG. 2 illustrates one embodiment of example task parameters and descriptions.

FIG. 3 illustrates one embodiment of a method associated with optimizing a sequence of tasks from a process template.

FIG. 4 illustrates an embodiment of a computing system configured with the example systems and/or methods disclosed.

### DETAILED DESCRIPTION

Systems and methods are described herein that are associated with optimizing the execution of the process that includes a sequence of tasks. In one embodiment, a process optimization system may include one or more machine learning models trained and configured to analyze prior executions of a specific process type to identify various combinations of tasks, sequences of tasks, and task parameters during execution cycle that performed efficiently and those combinations that did not perform efficiently, based on historical logs of execution data.

For example, bottlenecks or delays may be identified that are associated with certain conditions of a sequence of tasks that were performed for a particular process. Bottlenecks may include, but are not limited to, poor sequencing of tasks, poor staff assignments to particular tasks, redundancies in tasks, system failures, etc. The learned information and learned patterns may be used to identify ways to change the predefined execution sequence of tasks of a process type and suggest optimizations to the execution sequence. The proposed execution sequence of tasks may then be automatically modified in a process template, which is used to define can configure future executions of the process.

The process optimization system and technique may be applied to different types of processes where each different type of process has a specific assigned process template. In one embodiment, the process template for a process type is configured with a predefined sequence of tasks to be scheduled and performed to complete the process. Different processes are performed with different types of tasks and different sequences of tasks. The process template may define the tasks, a sequence of tasks to be executed, and task parameters. For example, task parameters may include, but are not limited to, scheduling parameters, execution variables/conditions, staff assignments/responsibilities to tasks, resources assigned, and other variables to complete a specific type of process. The process template may also identify relationships and dependencies between the tasks in the sequence that affect the order of execution of the sequence.

In a system, a deployed version of the process template is a blueprint, framework, and/or standardized guide used to create, customize, and/or control every execution instance of the associated process type. Typically, the process will be executed in a reoccurring manner at different time intervals and each execution is based on the assigned process template (e.g., deployed version) to ensure consistency, efficiency, and accuracy across multiple execution cycles/instances of the same process.

A unique aspect of the present system is that the process template (with a predefined sequence of tasks) is used to control the next scheduled execution of a process. Since the process is executed repeatedly on a regular basis, the previous executions of the process were also based on the same process template.

Thus, the system may have a history of execution logs for the same process type that performs the same or similar set of tasks, which were all based on the same process template blueprint. This common execution history can be used for training a machine learning model to learn patterns where there are bottlenecks and other types of delays in the execution of the process type as well as learn patterns where tasks were performed efficiently. However, tasks and parameters may be modified from the process template to customize a particular execution cycle. Thus, every execution cycle may not have the exact same task sequences or parameters.

The present process optimization system may be configured to optimize the process template by reordering the predefined sequence of tasks and/or task parameters. In one embodiment, a process template may define a sequence of tasks to be performed to complete a close process. For example, a close process is a process to close the books of an organization every month.

The present optimization system may be configured to analyze a process template and the sequence of tasks defined therein for a process. The system may then generate an optimized task sequence and other task recommendations based on historical performance data that has been observed for the same process type. The optimized sequence of tasks is predicted to be an improvement to the original sequence where the optimized sequence of tasks may be executed with improved performance metrics (e.g., executed in less time, with fewer errors, and/or with reduced bottlenecks, etc.).

### Overall System and ML Model Training Embodiment

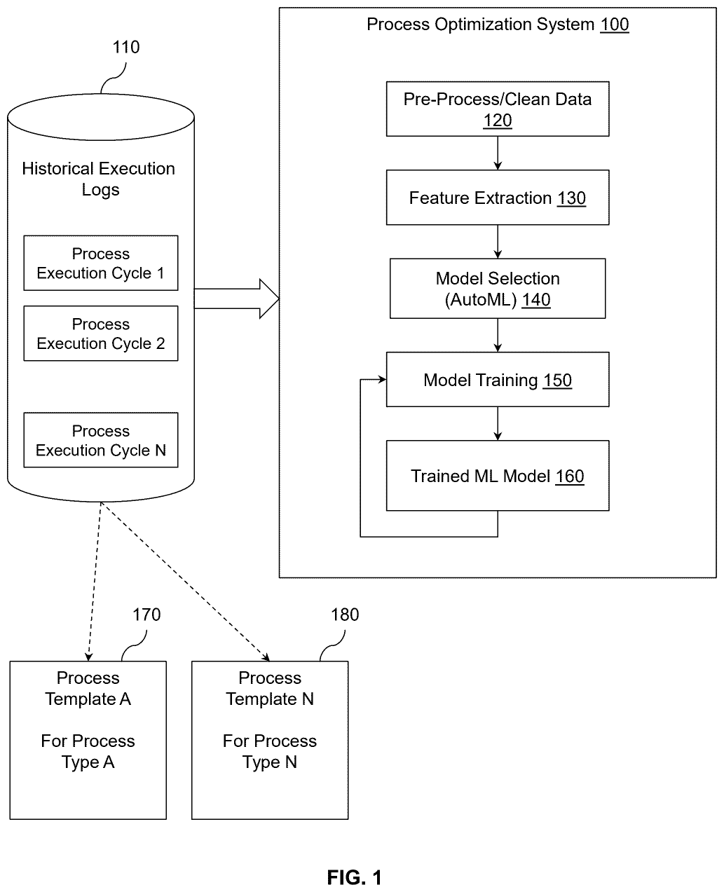

With reference to FIG. 1, one embodiment of a process optimization system 100 is illustrated that is associated with creating and training a machine learning (ML) model to optimize a sequence of tasks in a process template assigned to a specific type of process (process type).

In one embodiment, historical execution and performance data for a particular process type may be accessed from historical logs 110. The historical logs 110, for a particular process type, may be obtained by one or more software systems, applications or products that monitor, track, and record the processes of a system or organization. In one embodiment, each time a process is executed (e.g., single execution cycle/instance), a separate execution log is created for each repeated execution.

For example, when the process type is executed on a monthly basis, a separate execution log is created for each month, for example as shown in FIG. 1, process execution cycle 1, process execution cycle 2, and process execution cycle N. For each execution cycle, the execution log data may be used to calculate performance metrics associated with executing the process and executing specific tasks that were performed during the process. This data may be part of the historical log data 110 that may be used to train an ML model.

As previously explained, different process types have different assigned process templates (e.g., a deployed version) that is a standardized guide used to control every execution cycle of the associated process type. Accordingly, the execution of a process, and thus the execution log data collected during an execution cycle of the process, is a result of the execution following the process template definitions.

For example, tasks and activities performed may be tracked fora company's close process associated with an accounting software system to close the books for financial accounting. The close process is performed monthly, quarterly and yearly and may involve thousands of different activities from hundreds of different users. The activities may include automated activities like loading and consolidating data, generating reports, but also reviewing numbers, updating journals, etc. There are many different tasks and different activities that large numbers of people go through at the end of every month and every quarter to make sure the financial numbers are correct and that the financials get reported correctly. These tasks, task sequences, parameters, activities, staff assignments, resource assignments, scheduling dates, etc. may be predefined in the process template assigned to the close process.

In one embodiment, execution tracking systems may be cloud-based and implemented/integrated as part of larger applications. The tracking systems may track computer-executed actions that hundreds of users are doing on thousands of tasks that are performed during a particular type of process. In some embodiments, each historical log may comprise structured data representing a sequence of executed tasks during a single execution cycle/instance of the process. The historical log may be used by the system for analysis, monitoring, and/or determining performance metrics. For example, for an execution cycle, the execution log data may be used to calculate performance metrics associated with executing the process and executing specific tasks that were performed during the process. This data may be part of the historical log data 110 that may be used to train an ML model.

In some embodiments, the historical logs 110 may be configured and stored in various digital formats for example, but not limited to, flat files (e.g., .log, .csv), relational databases (e.g., MySQL, PostgreSQL), NoSQL databases (e.g., MongoDB, Cassandra), time-series databases (e.g., InfluxDB, Prometheus), log indexing systems (e.g., Elasticsearch, Graylog), or other suitable log formats. The logs may be indexed or associated with a time-series database to facilitate efficient retrieval and analysis. The historical logs 110 can be used as training data for a machine learning model configured to predict or optimize future execution sequences based on prior performance as described herein.

For example, when integrated with a financial consolidation close service (e.g., one process type), the tracking system may track the financial consolidation and close process that are performed. When integrated in a tax reporting system (e.g., a second process type), the tracking system may track the activities executed around a tax reporting process. When integrated with a planning and budgeting cloud service (e.g., third process type), the tracking system may track numerous activities that are performed around planning and budgeting tasks of a planning process.

The historical log 110 for an execution cycle may include, but is not limited to, the following fields: (i) a process type identifier; (ii) an execution cycle identifier uniquely identifying the execution cycle; (iii) a start timestamp and end timestamp of the execution cycle; (iv) a sequence of task records, wherein each task record includes at least a task identifier, an actual start time, an actual end time, and one or more performance metrics associated with execution of the task; and (v) an outcome indicator representing a result of the execution cycle and/or an outcome indicator for particular tasks that were executed.

In one embodiment where the process type is a close process, the close process may have been performed on a monthly basis for the last two years. Thus, the close process may have twenty-four (24) execution cycles in the last two years. Accordingly, there should be 24 historical execution logs in the historical log data 110. As previously stated, each execution of the close process is defined by a sequence of tasks (based on an assigned process template) that were performed to complete the process. Each execution log includes data describing how the close process was performed and handled during each execution cycle.

Although based on a process template, each close process may have been executed with slightly different sequences of tasks and with different assigned task parameters, which may include different staff assignments to tasks. As such, some task sequences performed better (e.g., resulted in higher performance metrics) compared to other task sequences and some task sequences performed worse (e.g., resulted in lower performance metrics) than other task sequences. This may be determined from performance metrics calculated from the execution data of the historical logs for execution cycles. Overall, the historical logs 110 for a particular type of process includes a vast amount of data and metrics (which could span over years) that are impossible for anyone to reasonably handle manually and make sense of.

Furthermore, for a execution cycle of a process type, the system knows where the process was sourced from because the process type is controlled by its assigned process template. That allows the system to identify and link back to the specific process template that was used for executing the process and was responsible for last 12, 24, or N execution cycles and its historical base. So, there is a direct linkage from the execution cycles/schedules of a process type back to the process template to where they were sourced from. For example, the system may have multiple process templates such as a process template A 170 assigned to process type A, process template N 180 assigned to process type N, etc.

In one embodiment, the present optimization system is configured to use at least a portion of the stored historical logs 110 as input to a machine learning (ML) model. The ML model may then be trained to learn performance characteristics of different sequences of tasks associated with a process type. Examples are described below.

### Feature Selection Embodiment

With continued reference to FIG. 1, at block 120, in one embodiment, the historical logs 110 may be initially pre-processed to understand its structure, schema, including column names, data types, and the nature of each attribute/variable. The raw historical data may be cleaned in a variety of ways, for example but not limited to, handling missing values, scaling values, encoding into numerical values, etc.

In one embodiment, to facilitate model training, categorical data, text, and string values (e.g., task names or outcome labels) may be transformed/converted into numerical representations using encoding techniques and scaled to ensure they are on a similar scale. These may include, but are not limited to, one-hot encoding or label encoding. Continuous variables may be normalized or scaled to a consistent range using methods such as min-max scaling or z-score standardization.

At block 130, a feature selection process may be performed to identify and extract relevant attributes from the historical logs 110, which are used to generate feature vectors. Relevant features selected may include some set of attributes or all of the attributes contained in data tables of the execution logs and performance metrics. A feature vector may be a 1-dimensional array of numerical values that represent properties of an executed task, in one embodiment. The feature vectors are used to train an ML model.

In general, creating feature vectors may include converting the raw data of the historical execution logs 110 into a standard format (a feature vector) so that all the feature vectors (e.g., the ML model training data) has the same uniform data structure and types of values. Different historical logs may have different attributes, different formats, and/or attribute values. The ML model expects a consistent input structure to correctly learn and apply patterns across the input data. If the feature vectors had different formats, different amounts of attributes, and/or different orders of attributes, the ML model may not be able to interpret the data correctly and may learn incorrect associations. Thus, the raw data is transformed into feature vectors that have a uniform, consistent length and data structure.

In some embodiments, the process optimization system 100 is configured to select and extract features from a plurality of historical logs corresponding to execution cycles of a process type, for the purpose of training the ML model.

As previously stated, each historical log represents a distinct execution cycle of a process type and comprises data including, but not limited to: process type, a sequence of executed tasks, task identifiers, task execution start and end timestamps, task parameters, task staff assignments, performance metrics associated with each task (e.g., duration, CPU usage, memory consumption), outcome indicators, and/or contextual metadata (e.g., time of day, system load, or geographic region).

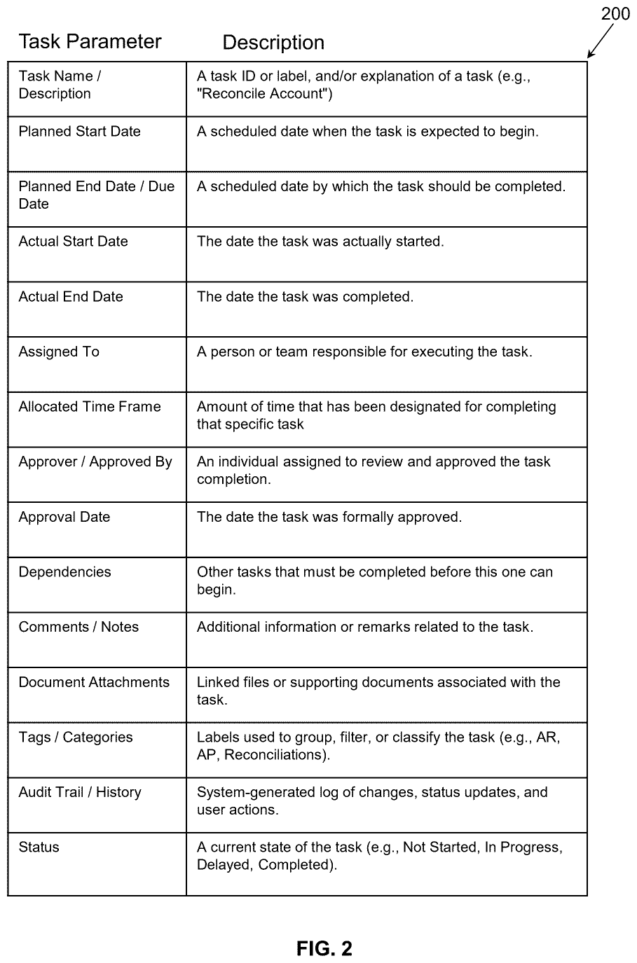

FIG. 2 illustrates a table 200 with example task parameters and descriptions that may be assigned to a task and may be defined in a process template. The task parameters may be collected as part of the execution log. There may be hundreds of features selected depending on the execution data collected and the types of historical log data. Selected features may be scaled to ensure they are on a similar scale. The selected features may then be formatted and transformed to be compatible for a chosen machine learning algorithm.

Additional examples of task parameters (and example descriptions) that may exist and be selected for training may include, but not limited to:

Task Metadata: Each task may have a unique task identifier, a title or description, and priority level; start and end date/time assigned to the task, allocated time frame, date and time stamps for when a task was actually created, assigned, initiated, modified, and completed. The time stamps allow for measurement of the time taken for each task and whether the task was completed as scheduled or was late.

Staff Assignments (Employee and Department Information): Details about the individuals assigned to each task or teams responsible for each task. This may include their usernames, roles, departments, and any changes in task ownership or reassignment. The historical logs may also identify which assigned staff (assigned users) performed certain tasks well, which assigned staff did not perform certain tasks well, which users consistently finished tasks early or late. This may help in tracking accountability and understanding how to optimize staff assignments to specific tasks in the workflow.

Task Status and Progress: The real-time status of tasks (e.g., not started, in progress, awaiting approval, completed, or delayed) that monitor the task progress against defined deadlines or milestones. This provides visibility into bottlenecks.

Action Logs: Details may be kept of actions taken during a task or associated process, such as data entries, edits, approvals, rejections, comments, or any manual overrides. These logs provide a transparent trail of activities and can be used for auditing and compliance purposes.

Error and Exception Management: This may include any errors, discrepancies, or exceptions that occurred during a task or the process, including details on what went wrong, the cause of the issue, and/or any corrective actions taken.

Performance Metrics: Key performance indicators (KPIs) may be included such as average time to complete tasks, frequency of errors, volume of transactions processed, and employee efficiency. This may be used to assess the overall effectiveness and efficiency of tasks and the performance of the overall process as performed by a particular sequence of tasks.

Some performance metrics for particular tasks or for particular people are not always consistent. For example, a user may be faster at a certain task four months out of the year, and then have a delay one month out of the year. There may be a certain sequence of tasks that are performed smoothly together and have consistently finished ahead of schedule. Sometimes a sequence of tasks might finish behind schedule.

Other performance metrics may be determined for each task that was performed. In one embodiment, using the close process example, the historical log data may identify when the close process completed late, when the close process completed early, which tasks were delayed, which task were completed late, what were causes for delays, and/or which tasks were completed early. These are types of patterns that the ML model 160 may be configured to learn.

With further reference to FIG. 1 and block 130, the feature selection and extraction process may include, but not limited to, the following steps. The process optimization system may retrieve the historical logs from a structured data repository and parse each log to identify its constituent elements, such as the ordered list of tasks, task-level attributes, and global execution metadata.

In one embodiment, task-level feature vectors may be generated from the historical log from an execution cycle. The task-level feature vectors allow the ML model to learn localized patterns representing, for example, what happened before and after a task is performed; how the position and/or order of tasks impacted the performance metrics and execution performance of the process; how specific tasks behave in different sequence contexts; how specific tasks performed with different staff assignments and/or other assigned variables.

The optimization system 100 may identify candidate features for extraction that may serve as input variables to the machine learning model. These features may include, for example but not limited to, process-level data and/or task-level data: the total number of tasks executed in a cycle; the order or position of each task in the sequence; task-level durations or resource usage metrics; inter-task timing gaps and dependencies; outcome indicators (e.g., success, failure, timeout, delayed, completed early, completed late, etc.); frequency of specific task combinations; temporal or environmental metadata (e.g., time of execution, user group, hardware type); and/or process-level and/or task-level performance metrics calculated from an execution cycle.

In some embodiments, when the sequence or ordering of tasks is relevant for a process type, the optimization system may encode the task sequences using sequence embedding techniques, n-gram representations, or position-aware encodings to preserve temporal and structural information.

In some embodiments, statistical or algorithmic methods may be applied to evaluate the relevance of candidate features. This may include techniques such as correlation analysis; feature importance ranking (e.g., using information gain or Gini importance); recursive feature elimination; and/or dimensionality reduction (e.g., PCA or autoencoders) to retain features that exhibit predictive value with respect to one or more target variables (e.g., execution time, success rate, resource usage).

For an individual historical log representing one execution cycle of the process type, the system may generate corresponding feature vectors comprising the selected and encoded features. These feature vectors form the training dataset used for supervised or unsupervised machine learning.

At block 140, a machine learning model may be selected for training from a set of available ML model types. In one embodiment, an automatic machine learning process (e.g., AutoML) may be implemented as described below.

### Machine Learning Model Training

With continued reference to FIG. 1, at block 150, in one embodiment, the process optimization system 110 trains the selected ML model 160 to evaluate a proposed sequence of tasks for a particular process type and generate an optimized sequence of tasks based on learned patterns from historical log data for the same process type. In some embodiments, the optimization system 100 may train and configure a different ML model for different process types.

Training data for the ML model 160 may include the feature vectors generated previously from the historical log data 110 for the particular process type. As explained, each time the process type was executed (e.g., a single execution cycle), the execution cycle has a different set of feature vectors. The feature vectors may represent a particular sequence of tasks performed during that execution cycle, with associated metadata, task parameters, performance metrics and outcomes.

In one embodiment, the ML model 160 is trained on the historical execution logs for a particular process type. During training, the model internalizes patterns that distinguish task conditions or configurations that typically result in efficient execution (e.g., short duration, low resource use) from those associated with poor performance (e.g., delays, errors, high cost). The ML model adjusts model parameters and learns task relationships and execution parameters to capture different performance outcomes. The ML model 160 may learn and create internalized patterns that identify delays associated with particular tasks and assigned task parameters, and identify delays associated with particular sequences of tasks based on at least the different performance metrics. In this manner, the ML model 160 may identify root causes of delays in particular tasks and/or particular sequences of tasks.

As another example, patterns may be learned from task relationships to capture recurring task sequences that led to higher performance metrics. Other patterns may be learned from task relationships to capture recurring task sequences that led to lower performance metrics. The trained ML model 160 may encode the learned patterns/relationships between task sequences and performance outcomes, which it uses to predict optimal configurations of task sequences and their assigned task parameters.

The process optimization system 100 uses the constructed feature vectors to train the ML model configured to learn relationships between process execution characteristics and outcomes, and/or to predict future performance metrics for new task sequences. Using the predictions, the ML model may generate an optimized sequence of tasks for a proposed sequence of tasks that is being evaluated.

In this manner, the present optimization system may train the ML model 160 to analyze different data points and figure out, within sequences of tasks, what is an optimal way of performing the sequence for a certain process type. The ML model 160 may also be trained to determine what is an optimal way of assigning and deploying specific people to a task or group of tasks within a process. The ML model may be trained to determine what is an optimal way of assigning other types of parameters/variables to a task to improve its execution efficiency. In general, the training set of data is used to teach the ML model to recognize patterns and relationships between the input features and one or more target variables that the ML model is trained to predict or estimate.

In this manner, the trained ML model 160 may identify and determine an optimal pathing and optimal assignments for different tasks of a process based on previously observed task sequences, combinations of tasks and assignments, what conditions existed during certain points in time, and the observed performance metrics that resulted, etc.

Bottlenecks and other delays can be identified from learned patterns for certain tasks and for certain sequences of tasks from the historical log data. Based on, for example, the observed combination of task parameters and/or conditions that occurred during the performance of the tasks, the ML model 160 learns to predict an optimal sequence of tasks for a process under similar conditions to avoid delays.

In one embodiment, the ML model 160 may be validated using a separate set of historical logs to evaluate its predictive accuracy and generalization performance. Evaluation metrics may include precision, recall, F1-score, mean squared error, or other suitable indicators.

Once trained, the ML model 160 may be deployed and used to evaluate new or proposed task sequences to predict expected performance, recommend task reordering, and/or suggest parameter adjustments to optimize execution of the process.

After training, the ML model 160 may contain thousands or millions of learned parameters that are part of the internalized patterns learned. These represent nonlinear patterns and multi-dimensional relationships between features that were learned from historical log data. In one embodiment, the learned parameters define boundaries, surfaces, or manifolds in a multi-dimensional vector space that separate different outcomes. For example, the ML model 160 may be trained to map patterns of process-level and/or task-level feature vectors into a multi-dimensional vector space, where the relative positioning of vectors reflects performance characteristics of task sequences, such as execution efficiency.

In one embodiment, during training, the ML model 160, such as a neural network or sequence model, may learn a latent representation space in which task sequences that lead to highly efficient execution outcomes (e.g., low total duration, minimal resource usage) are mapped to regions of the space that are proximate to one another. Conversely, task sequences associated with poor performance (e.g., delays, bottlenecks, failures) are mapped to distinct or more distant regions of the multi-dimensional space.

This learned vector space allows the model to internalize and distinguish between patterns of feature vectors associated with desirable and undesirable execution behaviors. The distance or similarity between points in the space may reflect differences in execution efficiency, sequence structure, or task parameter combinations.

In some embodiments, a classifier or scoring function may operate on this embedded representation to assign a performance score or category to a given task sequence. This enables the ML model 160 to evaluate new or proposed task sequences by projecting them into the learned vector space and determining their proximity to known efficient or inefficient regions.

This mapping may facilitate process optimization by enabling the optimization system 100 to predict whether a candidate task sequence (based on its feature vectors) is likely to result in efficient execution, based on its location in the learned vector space relative to historical patterns. This includes a decision of multi-dimensional similarity, for example. Multi-dimensional similarity refers to how similar or close two data points are when measured in the multi-dimensional space with multiple features (multiple dimensions).

Thus, a candidate feature vector representing a candidate sequence of tasks is placed in the multi-dimensional vector space of the ML model 160 to decide what other feature vector(s) are closest based on multi-dimensional similarity. This process is far too complex and fast to be replicated manually or mentally by a human for at least the reason that humans cannot operate with or process data with even 5-dimensions from thousands of transactions, let alone with dozens or hundreds of dimensions.

In one embodiment, the learned internalized patterns may be stored memory, in RAM, on a solid-state device, and/or GPU memory. In other embodiments, Programmable Logic Devices (PLDs) such as Field Programmable Gate Arrays (FPGAs) can be used to implement the patterns and/or neural networks of the ML model directly in hardware. The weights and structure of the ML model may be converted into logic gates or embedded RAM blocks.

### ML Model Feedback—Tuning

In some embodiments, the optimization system may iteratively refine the set of features by analyzing model performance metrics and retrain/tune the ML model with modified feature sets. Model performance metrics provide feedback to the ML model, and model parameters may be updated. Tuning may be performed on a periodic basis. For example, the ML model may be tuned based on new feedback data by retraining or fine-tuning the model with updated examples that include corrected labels or corrected outcomes from different execution historical logs for the process type. This feedback helps the ML model learn from recent mistakes and/or adapt to changing patterns in the data. The retraining/retuning process may involve adjusting model parameters, updating hyperparameters, or incorporating online learning, where the ML model incrementally learns from each new data point. The tuning improves the ML model's accuracy and relevance over time. The trained model may subsequently be used to evaluate or optimize new execution sequences for the process type.

### Selection of ML Model Embodiment

In one embodiment of block 140 in FIG. 1, a particular ML model may be selected for training from an available set of algorithms (e.g., Random Forest, XGBoost, Neural Nets, etc.) by a user interface selection. The selected model may be trained as described above.

In another embodiment, an automated machine learning (AutoML) process may be implemented that identifies and selects an optimal ML model for the type of training data and objective from multiple available ML models. For example, AutoML may be used to automate the end-to-end tasks of applying machine learning to the historical logs 110. The AutoML process may include selecting the best ML model for the historical log data from multiple available ML models. For example, AutoML automatically searches, builds/trains, and evaluates different ML model algorithms and hyperparameters based on the historical logs. AutoML compares results of the different ML models and identifies a high-performing model with a high degree of accuracy. In this case, the accuracy relates to accurately predicting which task sequence for a process type performs better (with higher performance metrics) than a proposed task sequence being evaluated.

For example, the AutoML process may automatically perform the following functions. It may clean and preprocess the data (e.g., handling missing values, scaling the data, encoding into numerical values, etc.). Relevant features may be selected and extracted from the journal entry data structure (e.g., feature engineering and reduction), which creates feature vectors. A feature vector may be a 1-dimensional array of numerical values, in one embodiment.

Using the feature vectors as input, multiple types of models (e.g., Random Forest, XGBoost, Neural Nets, etc.) may be trained and tested. For each model, AutoML may tune hyperparameters using optimization techniques (e.g., grid search, Bayesian optimization, etc.). Each trained model is tested and evaluated for performance using metrics (e.g., accuracy, AUC, F1-score, etc.). The testing may be based on inputting a proposed sequence of tasks fora process that the ML model was not trained with to measure accuracy in improving the performance metrics with a different sequence of tasks as recommended by the ML mode. The best-performing model may then be selected based on an objective to accurately predict and recommend an optimized task sequence. The selected trained ML model may then be deployed or exported for production. In one embodiment, the ML model may be tuned as previously described.

### Example Operation and Optimization of Task Sequences

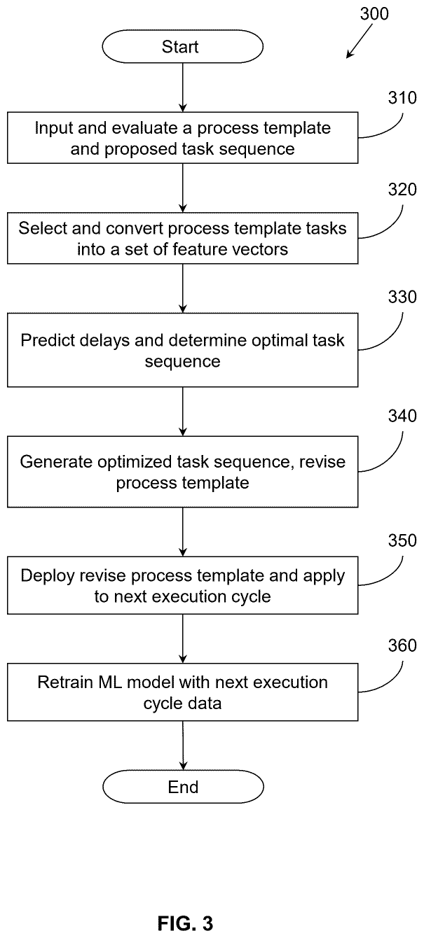

With reference to FIG. 3, one embodiment of an optimization method 300 is illustrated that may be associated with the process optimization system 110 and ML model 160 as trained and discussed in FIG. 1. As previously explained, the ML model 160 may be trained for a particular process type to identify patterns of efficient task sequences and/or patterns that identify delays associated with (i) particular tasks and their assigned task parameters, (ii) particular combinations of tasks, and (iii) particular sequences of tasks from historical execution data of the process type.

In one embodiment, in operation, the ML model 160 may be used to evaluate a sequence of tasks (e.g., a proposed or candidate task sequence for evaluation) that has been defined for a particular process type. For example, the proposed sequence of tasks may come from a process template that is assigned to a particular process type.

As previously explained, different types of processes have different process templates. In one embodiment, the process template assigned to a process is configured with a predefined sequence of tasks to be performed to complete the process. The process template may also identify relationships and dependencies between the tasks in the sequence that affect the order of execution of the task sequence.

In a system, a deployed version of the process template is used as a blueprint to create a custom executable version for a specific execution instance of the process. In general, the process template functions as a standardized guide used to configure and control the execution of a process in a consistent manner across multiple execution cycles/instances of the same process. Typically, the process will be executed repeatedly at different time intervals based on the assigned process template. Thus, the multiple execution cycles of the process type are initiated from or based on the same standardized process template that is assigned to the process type.

In one embodiment, method 300 and the process optimization system 110 are configured to evaluate a process template assigned to a process type and optimize the predefine task sequence and/or task parameters. The process template may be a version of the standardized process template used during previous execution cycles of the same process type. As used herein, the process template being evaluated is referred to as a proposed, candidate, or target process template and its predefined task sequence as the proposed or candidate task sequence.

The proposed task sequence may also include other variables and parameters such as start and end dates for tasks, timelines and deadlines for tasks, assignment responsibilities, and resources required to complete the particular process as previously described.

At block 310, the optimization method is executed, and a process template is inputted into the machine learning model for evaluation. The process template includes a proposed sequence of tasks to be executed for completing the process type. For example, the process template may be accessed and retrieved from a database. The proposed sequence of tasks is evaluated by the ML model including any assigned task parameters for executing the process type. In one embodiment, the ML model will evaluate the proposed sequence of tasks and parameters based on at least the internalized patterns learned by the model.

At block 320, the process template and proposed sequence of tasks are analyzed and relevant features are identified and selected in a similar manner as the selected features from the training data used for the ML model. The selected features are converted into feature vectors in a similar manner as previously described. This allows the machine learning model to evaluate the proposed sequence of tasks based on a multi-dimensional similarity of the set of feature vectors to the learned localized patterns.

At block 330, the feature vectors representing the proposed sequence of tasks are inputted to the ML model 160. By inputting the target sequence of tasks into the ML model (e.g., the feature vectors), the ML model may evaluate the target sequence to predict potential delays and determine an optimal task sequence. The optimal task sequence, for example, is based on the ML model's trained knowledge (e.g., internalized patterns) of how the same process type has been performed historically under different combinations of conditions, different sequences of tasks, and different assigned variables. One or more delays may be predicted that are associated with the proposed sequence of tasks based on similar properties as in the internalized patterns.

At block 340, the machine learning model may generate an optimized sequence of tasks by changing an order of the proposed sequence of tasks. The optimization may also changing one or more of the assigned task parameters to reduce the one or more delays predicted. In one embodiment, the process template may be modified or reorganized with the optimized sequence of tasks and/or task parameters.

In one embodiment, the ML model may output one or more recommendations for changing particular task variables, particular staff assignments to task, etc. that are predicted to be more optimal than the ones found in the proposed process template. For example, the ML model 160 may determine and identify five (5) different changes to optimize the process template. An electronic alert messages may be generated and transmitted to a remove device to alert a primary user (e.g., user in charge of the process template) to approve the revised process template. The alert may cause the remove device to display the recommended changes and provide selectable option on a user interface to accept or deny the changes.

At block 350, the revised process template with its revised sequence of tasks may be deployed to the system. The newly deployed version may then be applied to the next execution cycle of the associate process type.

In one embodiment, method 300 may be initiated by a user or automatically, and be performed on a process template after the most current execution cycle of the process is completed. For example, method 300 is performed after the associated process and its current set of tasks are completed but before the next execution cycle of the process is initiated.

As mentioned, the process template is used to create task sequences for a process that is executed periodically. Thus, for a monthly-executed close process, the process template with its predefined task sequences may be optimized to generate a new task schedule, which will be applied to the next execution cycle of the close process. Thus, the method 300 may be automatically executed after completion of the next execution cycle of the process, which is executed with the optimized process template. As such, at block 360, newly collected execution data from the execution logs may be used to retrain or tune the ML model 160 with new feedback data.

In this manner, the system may be making modifications to a process template month-after-month for the next execution cycle. Changes to the process template may then be accepted and applied for the next execution cycle of the process. Accordingly, the process template and thus process may continuously improve over time and may dynamically change and adapt to changing system conditions that affect the execution of the process.

In one embodiment, the ML model 160 may be performed on the entire proposed sequence of tasks when the proposed sequence has a number of tasks that are below a threshold (e.g., fewer than 100 tasks). When the target sequence has hundreds or thousands of tasks, the ML model 160 may break up the target sequence into clusters of tasks. A data clustering algorithm may be used to identify clusters of tasks within the overall sequence and determine optimal sequences for each cluster. Then the ML model may run the optimized cluster sequences again across all the clusters of tasks to find out the optimal sequencing across all the clusters.

For example, one idea is that there are different types of tasks within the entire proposed task sequence and certain groups of tasks revolve around completing a certain objective. These are tasks that are seen to consistently run together to complete the objective. The tasks for completing the objective may be clustered and their sequencing may then be evaluated for optimization separate from other tasks that are not part of that objective. This may include optimizing the assigned variables for the tasks such as their scheduled start/end dates, staff assignments, or other parameters.

For example, a cluster in the target sequence may be identified for completing a monthly report (the objective). The monthly report has five (5) tasks associated with it such as a data consolidation task that has an allocated time of three (3) days, which upon completion, triggers the next task (e.g., a reporting task to run the monthly report). As currently scheduled in the target sequence, the reporting task is not expected to start until three days after the data consolation task starts.

The ML model may determine from historical data consolidation tasks (and associated recognized patterns) that the data consolidation task has typically completed in one day. Thus, the ML model will identify this assigned value/variable as a delay in the sequence. The ML model may then optimize the sequence by changing the allocated three days for the data consolidation task to be one day. As a result, the reporting task will be initiated sooner than originally scheduled thereby optimizing the cluster of tasks. This revision may then lead to other revisions in other tasks to obtain additional optimizations.

As another example, the ML model may evaluate staff assignments made to different types of tasks. Suppose the target sequence being evaluated has employee Bob Smith assigned to perform the reporting task. Based on the historical data (e.g., from recognized patterns), the ML model can determine that Bob Smith historically spent four (4) days completing a reporting task, which is identified as a delay.

The ML model may also identify a more efficient alternative and may identify that Jane Doe historically spends two (2) days completing the same reporting task. If Jane Doe is available during the scheduled time of the reporting task, the ML model may reassign the reporting task to Jane Doe (e.g., reassign the staff assignment variable for the task). This revision potentially optimizes the cluster of tasks even more to reduce the delay time.

Thus, the ML model may optimize not only the order of tasks in the target sequence but also optimize scheduled parameters/variables of a task such as its allocated time frame, start and end dates, assigned staff, and/or other parameters associated with a task.

In general, using the historical data, the ML model may consider many different data points and combination of variables/factors such as who worked on what tasks; what other conditions were going on during the time of a task (e.g., was there unusually high system loads); what types of tasks consistently run best together and in what order. Other historical information about systems may be considered, for example, the volume of data being reported on during a reporting task, or the volume of data being consolidated during a data consolidation task. The ML model attempts to make good estimates based on when things went well versus when things did not go well and applies those estimates to similar parameters and conditions found in the target sequence being evaluated.

The ML model may be configured to revise and optimize the target sequence of tasks in its associated process template toward the paths and sequences that worked effectively historically. One goal is to reduce the total amount of time spent to complete the process. Thus, when the optimized process template is used to configure a new execution instance of the associated process, the associated process will be executed according to the optimized sequence of tasks. It should then take less time to complete the process the next time it is executed than it took previously to complete the process.

The present process optimization system can dynamically adapt to different process conditions and different task sequences. This provides an improvement over prior techniques that used programmed rules based on numerous groups of customized Boolean filter clauses programmed as IF-THEN statements.

### Optimizing Process Template for Close Process Embodiment

In one embodiment, one example of a process type is close process associated with an accounting software system. The close process may be performed on a reoccurring basis at month-end for every month, as well as quarterly and yearly. In the system, a process template is assigned to the close process and includes a predefined sequence of tasks for performing the close process during each execution cycle.

In one embodiment, the process template for the close process may predefine a sequence of tasks as shown in Table 1. The listed tasks and the sequence are not intended to be limiting. The type of tasks and the order may change depending on a particular organization.

TABLE 1
Example Sequential Task List for Close Process

| | |
|---|---|
| 1. | Record All Transactions |

| | |
|---|---|
| • | Enter all customer invoices, vendor bills, payments, payroll, journal |
| | entries, and other financial transactions for the month. |

| | |
|---|---|
| 2. | Review Unposted or Draft Entries |

| | |
|---|---|
| • | Check for any unposted or incomplete transactions and ensure they are |
| | properly finalized. |

| | |
|---|---|
| 3. | Reconcile Bank Accounts |

| | |
|---|---|
| • | Match bank statement transactions with accounting records to confirm |
| | balances and identify any discrepancies. |

| | |
|---|---|
| 4. | Reconcile Credit Cards and Loans |

| | |
|---|---|
| • | Reconcile credit card statements, loan balances, and other liability |
| | accounts with supporting documentation. |

| | |
|---|---|
| 5. | Reconcile Subledgers to General Ledger |

| | |
|---|---|
| • | Ensure Accounts Receivable, Accounts Payable, Inventory, and other |
| | subledgers match their corresponding general ledger accounts. |

| | |
|---|---|
| 6. | Post Accrual Entries |

| | |
|---|---|
| • | Record accruals for unpaid expenses or unbilled revenue to reflect the |
| | correct period costs and income. |

| | |
|---|---|
| 7. | Adjust Prepaid and Deferred Items |

| | |
|---|---|
| • | Allocate prepaid expenses or recognize deferred revenue according to |
| | the period they relate to. |

| | |
|---|---|
| 8. | Record Depreciation and Amortization |

| | |
|---|---|
| • | Post journal entries for depreciation of fixed assets or amortization of |
| | intangible assets. |

| | |
|---|---|
| 9. | Review Trial Balance |

| | |
|---|---|
| • | Analyze the trial balance for any unusual entries, account |
| | misclassifications, or out-of-balance issues. |

| | |
|---|---|
| 10. | Generate Financial Statements |

| | |
|---|---|
| • | Create and review the Profit & Loss (Income Statement), Balance Sheet, |
| | and Cash Flow Statement. |

| | |
|---|---|
| 11. | Review and Approve Financial Reports |

| | |
|---|---|
| • | Validate financial accuracy and get management approval if needed. |

| | |
|---|---|
| 12. | Close the Accounting Period |

| | |
|---|---|
| • | Lock or close the period in the accounting software to prevent further |
| | changes. |

| | |
|---|---|
| 13. | Create Backups and Archive Reports |

| | |
|---|---|
| • | Save or export key reports and create system backups if not done |
| | automatically. |

| | |
|---|---|
| 14. | Communicate with Stakeholders |

| | |
|---|---|
| • | Generate and distribute finalized reports to relevant stakeholders, |
| | including internal teams, management, or auditors. |

Each task in a close process may have multiple metadata parameters associated with it. These parameters help with accountability, audit trails, performance tracking, and automation. FIG. 2 illustrates example task parameters/metadata and their descriptions that may be assigned to tasks and/or collected from tasks. These may be defined in the assigned process template.

In general, the process optimization system 100 may be configured to optimize the task sequences of a close process in the manner as previously described in FIGS. 1-3. Differences may include that the plurality of historical logs comprises execution data from multiple execution cycles of a close process. The proposed/candidate process template that is being evaluated is the template assigned to the close process and the machine learning model 160 is configured to generate the optimized sequence of tasks for the close process.

As a general description of a close process, at the end of each month, the accounting team begins by ensuring that all financial transactions for the period have been entered into the accounting system. This includes sales invoices, customer payments, vendor bills, employee expenses, payroll, and any other relevant journal entries. The goal is to capture a complete and accurate picture of all business activity that occurred during the month.

Once all transactions are entered, the next step may be to reconcile the organization's accounts. This typically involves matching the company's records with external statements, such as bank and credit card statements. The accounting software usually provides reconciliation tools that help users identify discrepancies and confirm that all transactions have been properly accounted for. Any differences must be investigated and corrected before proceeding.

After reconciliation, accountants review the general ledger and make any necessary adjustments. This includes entering accruals for expenses or revenues that have been incurred but not yet recorded, adjusting prepaid expenses, recognizing depreciation or amortization, and making corrections for misclassified entries. These adjustments ensure that the financial statements accurately reflect the company's performance for the month.

With all transactions recorded and adjustments made, financial reports are then generated and reviewed. Common reports include the profit and loss statement, balance sheet, and cash flow statement. These reports are analyzed for unusual variances or errors, and any final corrections are made to ensure accuracy and completeness.

Once the financial data has been finalized and approved, the accounting period is closed in the software. This prevents further changes to the data for that month, ensuring that the financial records remain consistent and auditable. Most accounting systems allow only authorized users to reopen a closed period, providing internal control over the financial reporting process.

Finally, the financial reports may be shared with management, stakeholders, or external auditors, depending on the organization's reporting needs. A backup of the accounting data may also be created for record-keeping purposes. This entire process, while sometimes time-consuming, is critical to maintaining accurate and reliable financial records for the business.

Data may be collected for these tasks during the execution of the close process, which may be stored in an execution log for the particular execution cycle as described previously. The ML model 160 may be trained on a set of historical executions logs to be able to generate an optimized task sequence for the process template as previously described.

### Cloud or Enterprise Embodiments

In one embodiment, the process optimization system 100 is a computing/data processing system including an application or collection of distributed applications for enterprise organizations. The system may include one or more computing devices operably connected to communicate over one or more communication networks via one or more network interfaces. The applications and system 100 may be configured to operate with or be implemented as a cloud-based networking system, a software as a service (SaaS) architecture, or other type of networked computing solution. In one embodiment, the system 100 is a centralized server-side application that provides at least the functions disclosed herein and that is accessed by many users via computing devices/terminals communicating with the computing system 100 (functioning as the server) over a computer network.

In one embodiment, one or more of the components described herein are configured as program modules stored in a non-transitory computer readable medium. The program modules are configured with stored instructions that when executed by at least a processor cause the computing device to perform the corresponding function(s) as described herein.

### Computing Device Embodiment

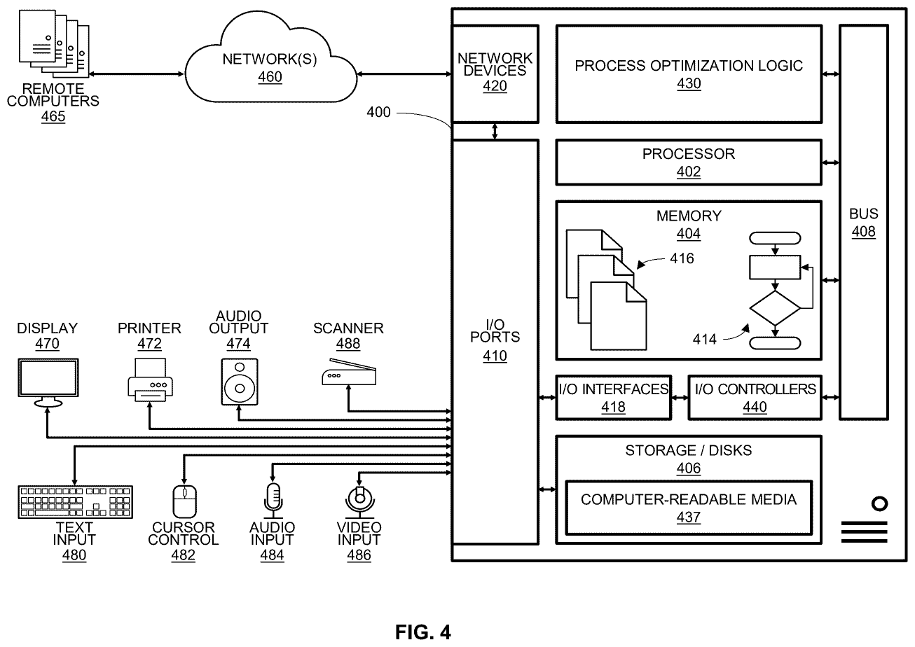

FIG. 4 illustrates an example computing device that is configured and/or programmed as a special purpose computing device with one or more of the example systems and methods described herein, and/or equivalents. The example computing device may be a computer 400 that includes at least one hardware processor 402, a memory 404, and input/output ports 410 operably connected by a bus 408. In one example, the computer 400 may include process optimization logic 430 configured to facilitate optimizing a sequence of tasks defined in a process template similar to process optimization system 100 shown in FIGS. 1 and/or 3.

In different examples, the logic 430 may be implemented in hardware, a non-transitory computer-readable medium 437 with stored instructions, firmware, and/or combinations thereof. While the logic 430 is illustrated as a hardware component attached to the bus 408, it is to be appreciated that in other embodiments, the logic 430 could be implemented in processor 402, stored in memory 404, or stored in disk 406.

In one embodiment, optimization logic 430 or the computer is a means (e.g., structure: hardware, non-transitory computer-readable medium, firmware) for performing the actions described. In some embodiments, the computing device may be a server operating in a cloud computing system, a server configured in a Software as a Service (SaaS) architecture, a smart phone, laptop, tablet computing device, and so on.

The means may be implemented, for example, as an ASIC programmed to facilitate optimizing a sequence of tasks defined in a process template. The means may also be implemented as stored computer executable instructions that are presented to computer 400 as data 416 that are temporarily stored in memory 404 and then executed by processor 402.

Logic 430 may also provide means (e.g., hardware, non-transitory computer-readable medium that stores executable instructions, firmware) for performing one or more of the disclosed functions and/or combinations of the functions.

Generally describing an example configuration of the computer 400, the processor 402 may be a variety of various processors including dual microprocessor and other multi-processor architectures. A memory 404 may include volatile memory and/or non-volatile memory. Non-volatile memory may include, for example, ROM, PROM, and so on. Volatile memory may include, for example, RAM, SRAM, DRAM, and so on.

A storage disk 406 may be operably connected to the computer 400 via, for example, an input/output (I/O) interface (e.g., card, device) 418 and an input/output port 410 that are controlled by at least an input/output (I/O) controller 440. The disk 406 may be, for example, a magnetic disk drive, a solid state disk drive, a floppy disk drive, a tape drive, a Zip drive, a flash memory card, a memory stick, and so on. Furthermore, the disk 406 may be a CD-ROM drive, a CD-R drive, a CD-RW drive, a DVD ROM, and so on. The memory 404 can store a process 414 and/or a data 416, for example. The disk 406 and/or the memory 404 can store an operating system that controls and allocates resources of the computer 400.

The computer 400 may interact with, control, and/or be controlled by input/output (I/O) devices via the input/output (I/O) controller 440, the I/O interfaces 418, and the input/output ports 410. Input/output devices may include, for example, one or more displays 470, printers 472 (such as inkjet, laser, or 3D printers), audio output devices 474 (such as speakers or headphones), text input devices 480 (such as keyboards), cursor control devices 482 for pointing and selection inputs (such as mice, trackballs, touch screens, joysticks, pointing sticks, electronic styluses, electronic pen tablets), audio input devices 484 (such as microphones or external audio players), video input devices 486 (such as video and still cameras, or external video players), image scanners 488, video cards (not shown), disks 406, network devices 420, and so on. The input/output ports 410 may include, for example, serial ports, parallel ports, and USB ports.

The computer 400 can operate in a network environment and thus may be connected to the network devices 420 via the I/O interfaces 418, and/or the 1/O ports 410. Through the network devices 420, the computer 400 may interact with a network 460. Through the network, the computer 400 may be logically connected to remote computers 465. Networks with which the computer 400 may interact include, but are not limited to, a LAN, a WAN, and other networks.

### Definitions and Other Embodiments

In another embodiment, the described methods and/or their equivalents may be implemented with computer executable instructions. Thus, in one embodiment, a non-transitory computer readable/storage medium is configured with stored computer executable instructions of an algorithm/executable application that when executed by a machine(s) cause the machine(s) (and/or associated components) to perform the method. Example machines include but are not limited to a processor, a computer, a server operating in a cloud computing system, a server configured in a Software as a Service (SaaS) architecture, a smart phone, and so on). In one embodiment, a computing device is implemented with one or more executable algorithms that are configured to perform any of the disclosed methods.

In one or more embodiments, the disclosed methods or their equivalents are performed by either: computer hardware configured to perform the method; or computer instructions embodied in a module stored in a non-transitory computer-readable medium where the instructions are configured as an executable algorithm configured to perform the method when executed by at least a processor of a computing device.

While for purposes of simplicity of explanation, the illustrated methodologies in the figures are shown and described as a series of blocks of an algorithm, it is to be appreciated that the methodologies are not limited by the order of the blocks. Some blocks can occur in different orders and/or concurrently with other blocks from that shown and described. Moreover, less than all the illustrated blocks may be used to implement an example methodology. Blocks may be combined or separated into multiple actions/components. Furthermore, additional and/or alternative methodologies can employ additional actions that are not illustrated in blocks.

The following includes definitions of selected terms employed herein. The definitions include various examples and/or forms of components that fall within the scope of a term and that may be used for implementation. The examples are not intended to be limiting. Both singular and plural forms of terms may be within the definitions.

References to “one embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

A “data structure”, as used herein, is an organization of data in a computing system that is stored in a memory, a storage device, or other computerized system. A data structure may be any one of, for example, a data field, a data file, a data array, a data record, a database, a data table, a graph, a tree, a linked list, and so on. A data structure may be formed from and contain many other data structures (e.g., a database includes many data records). Other examples of data structures are possible as well, in accordance with other embodiments.

“Computer-readable medium” or “computer storage medium”, as used herein, refers to a non-transitory medium that stores instructions and/or data configured to perform one or more of the disclosed functions when executed. Data may function as instructions in some embodiments. A computer-readable medium may take forms, including, but not limited to, non-volatile media, and volatile media. Non-volatile media may include, for example, optical disks, magnetic disks, and so on. Volatile media may include, for example, semiconductor memories, dynamic memory, and so on. Common forms of a computer-readable medium may include, but are not limited to, a floppy disk, a flexible disk, a hard disk, a magnetic tape, other magnetic medium, an application specific integrated circuit (ASIC), a programmable logic device, a compact disk (CD), other optical medium, a random access memory (RAM), a read only memory (ROM), a memory chip or card, a memory stick, solid state storage device (SSD), flash drive, and other media from which a computer, a processor or other electronic device can function with. Each type of media, if selected for implementation in one embodiment, may include stored instructions of an algorithm configured to perform one or more of the disclosed and/or claimed functions.

“Logic”, as used herein, represents a component that is implemented with computer or electrical hardware, a non-transitory medium with stored instructions of an executable application or program module, and/or combinations of these to perform any of the functions or actions as disclosed herein, and/or to cause a function or action from another logic, method, and/or system to be performed as disclosed herein. Equivalent logic may include firmware, a microprocessor programmed with an algorithm, a discrete logic (e.g., ASIC), at least one circuit, an analog circuit, a digital circuit, a programmed logic device, a memory device containing instructions of an algorithm, and so on, any of which may be configured to perform one or more of the disclosed functions. In one embodiment, logic may include one or more gates, combinations of gates, or other circuit components configured to perform one or more of the disclosed functions. Where multiple logics are described, it may be possible to incorporate the multiple logics into one logic. Similarly, where a single logic is described, it may be possible to distribute that single logic between multiple logics. In one embodiment, one or more of these logics are corresponding structure associated with performing the disclosed and/or claimed functions. Choice of which type of logic to implement may be based on desired system conditions or specifications. For example, if greater speed is a consideration, then hardware would be selected to implement functions. If a lower cost is a consideration, then stored instructions/executable application would be selected to implement the functions.

An “operable connection”, or a connection by which entities are “operably connected”, is one in which one or more communication channels are established (or may be established upon request) that allow signals, data, messages, physical communications, and/or logical communications to be sent and/or received between the entities. An operable connection may include a physical interface, an electrical interface, and/or a data interface with one or more transmitters and receivers that communicate with wired and/or wireless signals. An operable connection may include differing combinations of interfaces and/or connections sufficient to establish and allow communication. For example, two entities can be operably connected to communicate signals to each other directly or through one or more intermediate entities (e.g., processor, operating system, logic, non-transitory computer-readable medium, internet communication devices, local network, etc.). Logical and/or physical communication channels can be used to create an operable connection.

“User”, as used herein, includes but is not limited to one or more persons, computers or other devices, or combinations of these.

While the disclosed embodiments have been illustrated and described in considerable detail, it is not the intention to restrict or in any way limit the scope of the appended claims to such detail. It is, of course, not possible to describe every conceivable combination of components or methodologies for purposes of describing the various aspects of the subject matter. Therefore, the disclosure is not limited to the specific details or the illustrative examples shown and described.

To the extent that the term “includes” or “including” is employed in the detailed description or the claims, it is intended to be inclusive in a manner similar to the term “comprising” as that term is interpreted when employed as a transitional word in a claim.

To the extent that the term “or” is used in the detailed description or claims (e.g., A or B) it is intended to mean “A or B or both”. When intended to indicate “only A or B but not both” then the phrase “only A or B but not both” will be used. Thus, use of the term “or” herein is the inclusive, and not the exclusive use.

What is claimed is:

1. A computing system comprising:
one or more computing devices operably connected to communicate over one or more communication networks via one or more network interfaces;
at least one processor connected to at least one memory, wherein the at least one processor is operably connected to at least one of the one or more computing devices; and
a non-transitory computer readable medium including instructions stored thereon that when executed by at least the processor cause the computing system to:
train a machine learning model based on a plurality of historical logs that comprises execution data from multiple execution cycles of a process type;
wherein each historical log representing a distinct execution cycle performed at a different time, and containing data showing the process type executed with varying sequences of tasks associated with different performance metrics;
wherein the multiple execution cycles of the process type were initiated based on a standardized process template that is assigned to the process type;
train the machine learning model to learn and create internalized patterns that identify delays associated with particular tasks and assigned task parameters, and patterns that identify delays associated with particular sequences of tasks based on at least the different performance metrics;
execute an optimization by inputting, into the machine learning model, a candidate process template that is a version of the standardized process template, wherein the candidate process template includes a candidate sequence of tasks to be executed for completing the process type;
evaluate, by the machine learning model, the candidate sequence of tasks including assigned task parameters for executing the process type based on at least the internalized patterns;
predict, by the machine learning model, one or more delays associated with the candidate sequence of tasks based on similar properties as in the internalized patterns; and
generate, by the machine learning model, an optimized sequence of tasks for the candidate process template by changing an order of the candidate sequence of tasks and changing one or more of the assigned task parameters to reduce the one or more delays predicted.

2. The computing system of claim 1, wherein the machine learning model is configured with the internalized patterns in a multi-dimensional space that are learned from multi-dimensional combinations of features from the plurality of historical logs including task sequences, task parameters, and staff assignments to tasks; and
wherein the machine learning model is configured to evaluate the candidate sequence of tasks for executing the process type based on a multi-dimensional similarity of feature vectors in the internalized patterns.

3. The computing system of claim 1, wherein the process type is a close process associated with an accounting software system;
wherein the plurality of historical logs comprises execution data from multiple execution cycles of the close process;
wherein the candidate process template is assigned to the close process and wherein the candidate sequence of tasks defines tasks for performing the close process; and
wherein the machine learning model is configured to generate the optimized sequence of tasks for the close process and revise the candidate process template with the optimized sequence of tasks.

4. The computing system of claim 1,
wherein the assigned task parameters include a task name, a planned start date, a planned end date, an actual start date, and an actual end date; and
wherein the assigned task parameters further include task staff assignments comprising at least a username assigned to perform the task, and an approver name for approving the task.

5. The computing system of claim 1, wherein the instructions to train the machine learning model further comprising instructions that when executed by at least the processor cause the processor to:
access the plurality of historical logs from a log database, wherein each historical log for an execution cycle is a data structure including a plurality of execution data associated with a plurality of tasks that were performed during the execution cycle of the process type; and
convert the plurality of execution data into a set of feature vectors comprising task-level feature vectors for learning localized patterns representing what happened before and after a task is performed and how a position and order of tasks in the execution cycle impacted performance metrics of the process type during the execution cycle.

6. The computing system of claim 1, further comprising:
an autoML system configured to automatically create, train, and test a plurality of machine learning models based on the plurality of historical logs that comprise execution data from multiple execution cycles of the process type; and
wherein the autoML system is configured to select one machine learning model from the plurality of machine learning models having an optimal accuracy for predicting an improved sequence of tasks for the process type.

7. A non-transitory computer-readable medium that includes stored thereon computer-executable instructions that when executed by at least a processor of a computing system, wherein the computing system includes one or more computing devices, cause the computing system to:
train a machine learning model with a plurality of historical logs that comprises execution data from multiple execution cycles of a process type, wherein the process type includes a plurality of tasks that include task parameters comprising at least task execution parameters and task staff assignments;
wherein the plurality of historical logs comprises at least a first historical log including a first sequence of tasks having a first set of task parameters that were performed during a first execution cycle of the process type, and a second historical log including a second sequence of tasks having a second set of task parameters that were performed during a second execution cycle of the process type;
wherein the machine learning model is trained to learn patterns that identify delays associated with (i) particular tasks and their assigned parameters, (ii) particular combinations of tasks, and (iii) particular sequences of tasks;
perform an optimization by inputting a process template to the machine learning model, wherein the process template includes (i) a proposed sequence of tasks for executing the process type and (ii) a proposed set of task parameters including proposed task staff assignments for one or more of the tasks in the proposed sequence;
evaluate, by the machine learning model, the proposed sequence of tasks including the proposed set of task parameters for executing the process type based on at least the internalized patterns of the machine learning model;
predict, by the machine learning model, one or more predicted delays based on similar task sequences and combinations of task parameters as in the internalized patterns; and
generate, by the machine learning model, an optimized sequence of tasks for the process template by modifying the proposed sequence of tasks and changing one or more of the proposed set of task parameters based on the historical performance data for the process type that reduces the one or more delays.

8. The non-transitory computer-readable medium of claim 7, wherein the machine learning model is configured with the internalized patterns in a multi-dimensional space that are learned from multi-dimensional combinations of features from the plurality of historical logs including task sequences, task parameters, and staff assignments to tasks.

9. The non-transitory computer-readable medium of claim 7,
wherein the task parameters include a task name, a planned start date, a planned end date, an actual start date, and an actual end date; and
wherein the task staff assignments comprise at least a username assigned to perform the task, and an approver name for approving the task.

10. The non-transitory computer-readable medium of claim 7, wherein the process type is a close process associated with an accounting software system;
wherein the plurality of historical logs comprises execution data from multiple execution cycles of the close process;
wherein the process template is assigned to the close process and wherein the proposed sequence of tasks of the process template defines tasks for performing the close process; and
wherein the machine learning model is configured to generate the optimized sequence of tasks for the close process and revise the process template with the optimized sequence of tasks.

11. The non-transitory computer-readable medium of claim 7, wherein the instructions to train the machine learning model further comprising instructions that when executed by at least the processor cause the processor to:
access the plurality of historical logs from a log database, wherein each historical log for an execution cycle is a data structure including a plurality of execution data associated with a plurality of tasks that were performed during the execution cycle of the process type; and
convert the plurality of execution data into a set of feature vectors comprising task-level feature vectors for learning localized patterns representing what happened before and after a task is performed and how a position and order of tasks in the execution cycle impacted performance metrics of the process type during the execution cycle.

12. The non-transitory computer-readable medium of claim 11, further comprising instructions that when executed by at least the processor cause the processor to:
convert the proposed sequence of tasks including the proposed set of task parameters for executing the process type into a set of feature vectors; and
wherein the machine learning model is configured to evaluate the proposed sequence of tasks based on a multi-dimensional similarity of the set of feature vectors in the localized patterns to generate the optimized sequence of tasks.

13. The non-transitory computer-readable medium of claim 7, further comprising instructions that when executed by at least the processor cause the processor to:
automatically create, train, and test a plurality of machine learning models based on the plurality of historical logs that comprise execution data from multiple execution cycles of the process type; and
select one machine learning model from the plurality of machine learning models having an optimal accuracy for predicting an improved sequence of tasks for the process type.

14. The non-transitory computer-readable medium of claim 7, further comprising instructions that when executed by at least the processor cause the processor to:
tune the machine learning model based on at least new feedback data for retraining the machine learning model with updated examples that include corrected outcomes for generating the optimized sequence of tasks for the process type.

15. A computer-implemented method, the method comprising:
training a machine learning model based on a plurality of historical logs that comprises execution data from multiple execution cycles of a process type;
wherein each historical log representing a distinct execution cycle performed at a different time, and containing data showing the process type executed with varying sequences of tasks associated with different performance metrics;
training the machine learning model to learn and create internalized patterns that identify delays associated with particular tasks and assigned task parameters, and identify delays associated with particular sequences of tasks based on at least the different performance metrics;
executing an optimization by inputting, into the machine learning model, a process template that includes a proposed sequence of tasks to be executed for completing the process type;
evaluating, by the machine learning model, the proposed sequence of tasks including assigned task parameters for executing the process type based on at least the internalized patterns;
predicting, by the machine learning model, one or more delays associated with the proposed sequence of tasks based on similar properties as in the internalized patterns; and
generating, by the machine learning model, an optimized sequence of tasks by changing an order of the proposed sequence of tasks and changing one or more of the assigned task parameters to reduce the one or more delays predicted.

16. The method of claim 15, wherein the training further comprises:
training the machine learning model with the plurality of historical logs wherein the machine learning model learns and creates the internalized patterns associated with one or more sequences of tasks that resulted in higher performance metrics compared to other sequences of tasks, and learns and creates patterns associated with one or more sequences of tasks that resulted in lower performance metrics compared to other sequences of tasks.

17. The method of claim 15, wherein the process type is a close process associated with an accounting software system;
wherein the plurality of historical logs comprises execution data from multiple execution cycles of the close process;
wherein the process template is assigned to the close process and wherein the proposed sequence of tasks defines tasks for performing the close process; and
wherein generating the optimized sequence of tasks includes generating a revised order of the proposed sequence of tasks and changing one or more of the assigned task parameters for the close process.

18. The method of claim 15, further comprising:
accessing the plurality of historical logs from a log database, wherein each historical log for an execution cycle is a data structure including a plurality of execution data associated with a plurality of tasks that were performed during the execution cycle of the process type; and
converting the plurality of execution data into a set of feature vectors comprising task-level feature vectors for learning localized patterns representing what happened before and after a task is performed and how a position and order of tasks in the execution cycle impacted performance metrics of the process type during the execution cycle.

19. The method of claim 18, further comprising:
converting the proposed sequence of tasks including the proposed set of task parameters for executing the process type into a set of feature vectors; and
generating the optimized sequence of tasks based, at least in part, on evaluating the set of feature vectors based on a multi-dimensional similarity with the set of feature vectors in the localized patterns.

20. The method of claim 15, further comprising:
tuning the machine learning model based on at least new feedback data for retraining the machine learning model with updated examples that include corrected outcomes for generating the optimized sequence of tasks for the process type.
